(19) United States
(12) Patent Application Publication
(10) Pub. No.: US 2005/0158049 A1
(43) Pub. Date: Jul. 21, 2005

(54) Wavelength division multiplexed passive optical network

(76) Inventors: Gyu-Woong Lee, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(21) Appl. No.: 10/915,182

(22) Filed: Aug. 9, 2004

(30) Foreign Application Priority Data
Jan. 20, 2004 (KR) 2004-4183

(51) Int. Cl. H04J 14/00

(52) U.S. Cl. 398/71

(57) ABSTRACT

A wavelength division multiplexed passive optical network (WDM PON) is disclosed. In one aspect, WDM-PON comprises a central office comprising a plurality of semiconductor optical amplifiers each adapted to output an optical signal modulated in accordance with data inputted thereto, and a wavelength division multiplexer adapted to multiplex the optical signals outputted from the semiconductor optical amplifiers, and a remote node connected to the central office via a main optical fiber, adapted to distribute the optical signals received, on to corresponding distribution optical fibers connected thereto, and a plurality of optical network units connected to the remote node via corresponding distribution optical fibers, the optical network units receiving from the remote node the optical signals associated therewith. In another aspect of the invention, the central office further comprises an amplifier for amplifying the multiplexed signal.

### CLAIM of PRIORITY

This application claims priority, pursuant to 35 USC § 119, to that patent application entitled “WAVELENGTH DIVISION MULTIPLEXED PASSIVE OPTICAL NETWORK” filed in the Korean Intellectual Property Office on Jan. 20, 2004 and assigned Serial No. 2004-4183, the contents of which are hereby incorporated by reference.

### BACKGROUND OF THE INVENTION

1. Field of the Invention

The present invention relates to an optical communication network, and more particularly to a wavelength division multiplexed passive optical network.

2. Description of the Related Art

A wavelength division multiplexed (WDM) passive optical network (PON) can provide ultrahigh-speed broadband communication services by assigning specific wavelengths to respective subscribers. Accordingly, such a WDM PON ensures communication security, while being capable of easily accommodating a separate communication service required by a subscriber. The service is also easily expandable to accommodate user communication needs. Also, the WDM PON allows addition of a particular wavelength to be assigned to a new subscriber, so that it is possible to easily achieve an increase in the number of subscribers. In spite of such advantages, however, the WDM PON additionally requires, for a central office (CO) thereof and each optical network unit (ONU) thereof, light sources with a known oscillation wavelength, and wavelength stabilizing circuits adapted to stabilize the wavelength of the light sources. As a result, a heavy burden is imposed on the network and the subscriber's equipment.

WDM PONs have been proposed that use as a WDM light source either a distributed feedback (DFB) laser, a DFB laser array, a multi-frequency laser (MFL), a picosecond pulse light source, or the like. Recently, research has been conducted to use as an economical WDM light source either a spectrum-sliced light source requiring no wavelength selectivity and wavelength stability, a mode-locked Fabry-Perot laser with incoherent light, or a wavelength-seeded reflective semiconductor optical amplifier.

FIG. 1 is a schematic diagram illustrating a conventional WDM PON 100 and conventional means of obtaining stable wavelengths. The PON 100 includes a central office (CO) 110, a remote node (RN) 170 connected to the central office 110 via a main optical fiber (MF) 160, and a plurality of optical network units (ONUs), ONU₁ to ONUₙ 200-1 to 200-n, connected to the remote node 170 via n distribution optical fibers (DFs), DF₁ to DFₙ, 190-1 to 190-n, respectively. Hereinafter, the plurality of optical network units and the number of distribution optical fibers are referred to with regard to the conventional notation of arbitrary numbering “n”. However, while the number “n” is shown with regard to both the number of ONU and the number of DF and ports, one skilled in the art would recognize that the number of ONU and number of DF need not be the same. For example, the number of DF may be significantly greater than the number of ONU to allow for the incorporation of additional ONU at a future time.

The central office 110 includes “n” Fabry-Perot laser diodes (FP-LDs), FP-LD₁ to FP-LDₙ, 120-1 to 120-n, a first wavelength division multiplexer, WDM1, 130, a broadband light source (BLS) 140, and a circulator (CIR) 150.

The “n” FP-LDs 120-1 to 120-n output “n” optical signals as they are wavelength-locked by “n” different wavelengths, respectively. For example, the FP-LDₙ 120-n outputs an n-th optical signal as it is wavelength-locked by the n-th wavelength.

In this illustrated example, WDM1 130 includes a multiplexing port MP, and “n” de-multiplexing ports DP₁ to DPₙ. The multiplexing port MP of the WDM1 130 is connected to the circulator 150, whereas the “n” de-multiplexing ports DP₁ to DPₙ of the WDM1 130 are connected to corresponding FP-LDₙ 120-1 to FP-LDₙ 120-n. The WDM1 130 de-multiplexes a broadband optical signal inputted to the multiplexing port MP, and outputs de-multiplexed optical signals at the “n” de-multiplexing ports DP₁ to DPₙ. The WDM1 130 also multiplexes “n” optical signals inputted on corresponding de-multiplexing ports DP₁ to DPₙ and outputs the multiplexed optical signals at the multiplexing port MP.

Broadband light source 140 is connected to the circulator 150, and is adapted to output broadband incoherent light.

Circulator 150 includes three ports wherein the first port is connected to the broadband light source 140, the second port is connected to the multiplexing port MP of the WDM1 130, and the third port is connected to the main optical fiber 160. The circulator 150 outputs a broadband light, inputted to the first port to the second port, while outputting “n” optical signals, inputted to the second port to the third port.

The remote node 170 includes a second wavelength division multiplexer, WDM2, 180. The WDM2 180 includes a multiplexing port MP, and “n” de-multiplexing ports DP₁ to DPₙ. The multiplexing port of the WDM2 180 is connected to the main optical fiber (MF) 160, whereas the “n” de-multiplexing ports DP₁ to DPₙ of the WDM2 180 are connected to the “n” distribution optical fibers (DFs), DF₁ to DFₙ, 190-1 to 190-n, respectively. For example, the n-th de-multiplexing port DPₙ of the WDM2 180 is connected to the n-th distribution optical fiber, DFₙ, 190-n. The WDM2 180 de-multiplexes “n” optical signals inputted to the multiplexing port MP, and outputs the demultiplexed “n” optical signals to corresponding demultiplexing ports DP₁ to DPₙ.

The “n” ONUs, ONU₁ 200-1 to ONUₙ 200-n, are connected to corresponding distribution optical fibers 190-1 to 190-n. For example, the ONUₙ 200-n is connected to the n-th distribution optical fiber 190-n. Each ONU detects an optical signal received from the associated distribution optical fiber in the form of an electrical signal. For example, the ONUₙ 200-n detects an optical signal received from the n-th distribution optical fiber 190-n, in the form of an electrical signal.

As m entioned above, the conventional PON 100 additionally uses the broadband light source 140 used to wavelength-locked or wavelength-injected light source. The use of the broadband light source increases the cost of the conventional PON 100, and makes conventional PONs uneconomical. For this reason, the WDM PON has not been practically used. Therefore, it is necessary to develop an WDM light source in order to develop an economical WDM PON. Furthermore, where a bi-directional single transmitter/receiver module is used to secure a competitive cost, it is also necessary to take into consideration bands of input and output wavelengths.

### SUMMARY OF THE INVENTION

Therefore, the present invention has been made in view of the above mentioned problem involved with the related art, and an object of the invention is to provide a WDM PON which can be implemented without using a broadband light source.

In accordance with the present invention, this object is accomplished by providing a wavelength division multiplexed passive optical network (WDM PON) comprising a central office including a plurality of semiconductor optical amplifiers each adapted to output an optical signal modulated in accordance with data inputted thereto in association therewith, and a wavelength division multiplexer adapted to multiplex the optical signals respectively outputted from the semiconductor optical amplifiers, a remote node connected to the central office via a main optical fiber adapted to distribute the optical signals received to distribution optical fibers connected thereto, and a plurality of optical network units connected to the remote node via corresponding distribution optical fibers, the optical network units receiving, from the remote node, the optical signals associated therewith.

### BRIEF DESCRIPTION OF THE DRAWINGS

The above objects and advantages of the present invention will become more apparent by describing, in detail, embodiments with reference to the attached drawings in which:

FIG. 1 is a schematic diagram illustrating a conventional WDM PON;

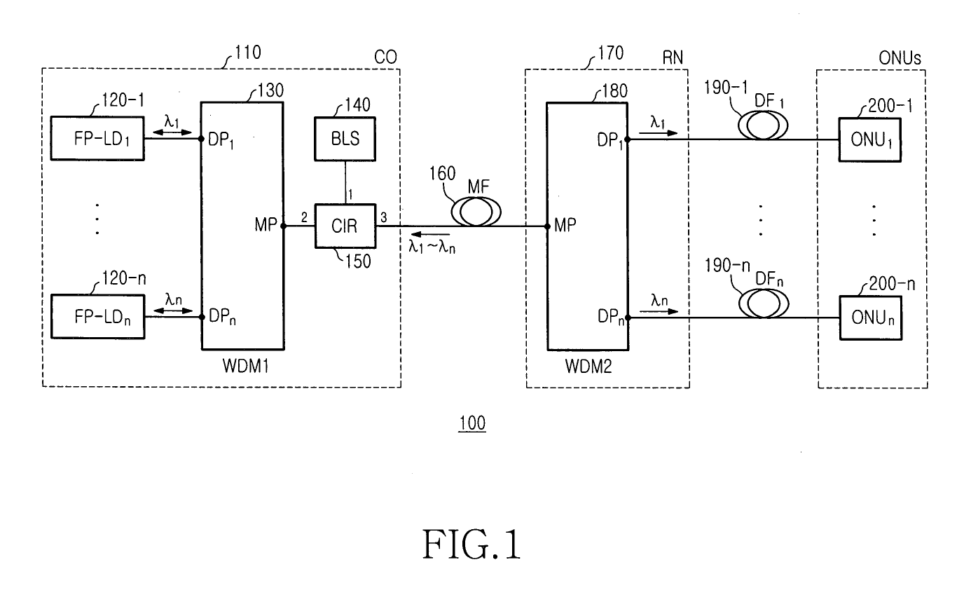

FIG. 2 is a schematic diagram illustrating a configuration of a WDM PON according to a first embodiment of the present invention;

FIG. 3 is a schematic diagram illustrating a configuration of a WDM PON according to a second embodiment of the present invention; and

FIG. 4 is a schematic diagram illustrating a configuration of a WDM PON according to a third embodiment of the present invention.

### DETAILED DESCRIPTION OF THE INVENTION

Embodiments of the present invention will now be described in detail with reference to the annexed drawings. For the purpose of clarity, a detailed description of known functions and configurations incorporated herein will be omitted when it may obscure the subject matter of the present invention.

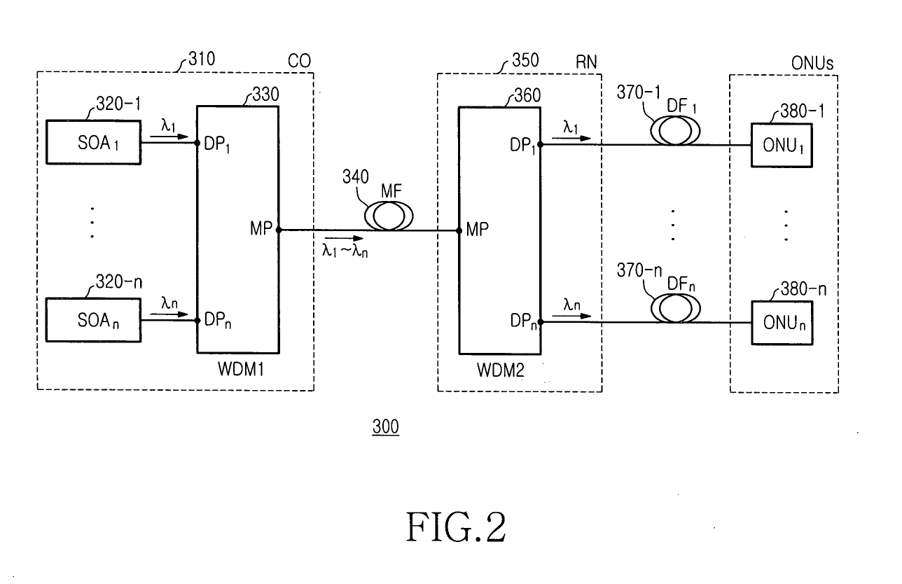

FIG. 2 illustrates a configuration of a WDM PON according to a first embodiment of the present invention. In this illustrative embodiment, the PON, 300, includes a central office (CO) 310, a remote node (RN) 350 connected to the central office 310 via a main optical fiber (MF) 340, and a plurality of optical network units (ONUs), ONU₁ to ONUₙ, 380-1 to 380-n, connected to the remote node 350 via a plurality of distribution optical fibers (DFs), DF₁ to DFₙ, 370-1 to 370-n, respectively.

The central office 110 includes n semiconductor optical amplifiers (SOAs), SOA, to SOAN, 320-1 to 320-n, and a first wavelength division multiplexer, WDM1, 330.

The SOA₁ 320-1 to SOAₙ 320-n output “n” optical signals, respectively. For example, the SOAₙ 320-n outputs an n-th optical signal modulated by associated data inputted thereto. Each of the SOA₁ 320-1 to SOAₙ 320-n may comprise a transmissive SOA requiring no wavelength selectivity and wavelength stability, a gain-clamped SOA (GC-SOA), or a reflective SOA (RSOA).

The WDM1 330 includes a multiplexing port MP, and “n” de-multiplexing ports DP₁ to DPₙ. The multiplexing port MP of the WDM1 330 is connected to the main optical fiber 340, whereas the “n” de-multiplexing ports DP₁ to DPₙ of the WDM1 330 are connected to the SOA₁ 320-1 to SOAₙ 320-n, respectively. The WDM1 330 multiplexes “n” optical signals inputted to the “n” de-multiplexing ports DP₁ to DPₙ and, outputs the multiplexed optical signal at the multiplexing port MP. In one aspect, the WDM1 330 may comprise an arrayed waveguide grating (AWG).

The remote node 350 includes a second wavelength division multiplexer, WDM2, 360. The WDM2 360 has a multiplexing port MP, and “n” de-multiplexing ports DP₁ to DPₙ. The multiplexing port of the WDM2 360 is connected to the main optical fiber (MF) 340, wherein the “n” de-multiplexing ports DP₁ to DPₙ of the WDM2 360 are connected to corresponding distribution optical fibers (DFs), DF₁ to DFₙ, 370-1 to 370-n. For example, the n-th de-multiplexing port DPₙ of the WDM2 360 is connected to the n-th distribution optical fiber, DFₙ, 370-n. The WDM2 360 de-multiplexes “n” optical signals inputted to the multiplexing port MP, and outputs the demultiplexed optical signals to the corresponding de-multiplexing ports DP₁ to DPₙ. In one aspect, the WDM2 360 may comprise an AWG.

The “n” ONUs, ONU₁ to ONUₙ, 380-1 to 380-n, are connected to corresponding distribution optical fibers, DF₁ to DFₙ, 370-1 to 370-n. For example, the ONUN 380-n is connected to the n-th distribution optical fiber, DFₙ, 370-n. Each ONU detects an optical signal received from the associated distribution optical fiber, in the form of an electrical signal. For example, the ONUₙ 380-n detects an optical signal received from the n-th distribution optical fiber, DFₙ, 190-n, in the form of an electrical signal.

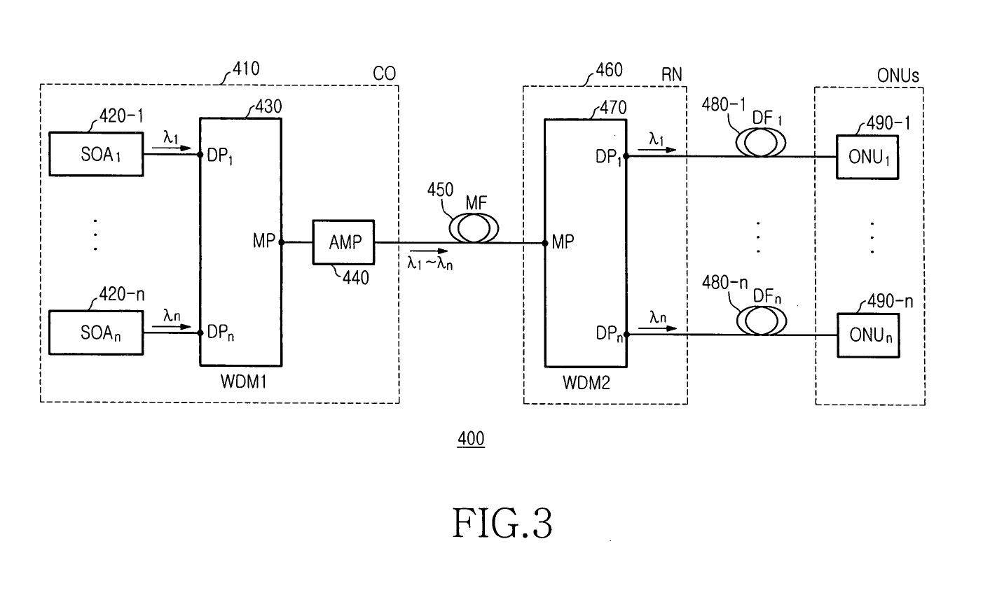

FIG. 3 illustrates a configuration of a WDM PON 400 according to a second embodiment of the present invention. The PON 400, has the same configuration as that shown in FIG. 2, with the addition of an optical amplifier 440 to the transmitter configuration shown in FIG. 2. Accordingly, the following description will be given of a configuration associated with the added optical amplifier.

In this illustrative embodiment, the optical amplifier (AMP) 440 in FIG. 3 is connected between a multiplexing port MP of a WDM1 430 and a main optical fiber (MF) 450. The optical amplifier 440 may comprise a transmissive SOA, a GC-SOA, or an RSOA.

Operation of the PON 400 will now be described. As discussed with regard to FIG. 2, “n” optical signals respectively outputted from the SOA₁ 420-1 to SOAₙ 420-n are inputted to the WDM1 430. The WDM1 430 receives the “n” optical signals at respective de-multiplexing ports DP₁ to DPₙ and multiplexes the received “n” optical signals. The multiplex signal available at the multiplexing port MP is inputted to optical amplifier 440. The optical amplifier 440 receives the multiplexed “n” optical signals from the WDM1 430, and amplifies each of the “n” optical signals. The amplified “n” optical signals are then inputted fiber 450 and provided to a WDM2 470, which is included in a remote node (RN) 460.

The WDM2 470 receives the multiplexed “n” optical signals at a multiplexing port MP and, de-multiplexes the received multiplexed optical signal into individual “n” optical signals. The de-multiplexed “n” optical signals are outputted to respective de-multiplexing ports DP₁ to DPₙ. The de-multiplexed “n” optical signals are provided to corresponding ONUs, ONU₁ to ONUₙ, 490-1 to 490-n, via an associated distribution optical fibers, DF₁ to DFₙ, 480-1 to 480-n. Each of the ONU₁ 490-1 to ONUₙ 490-n detect the optical signal inputted thereto, in the form of electrical signals.

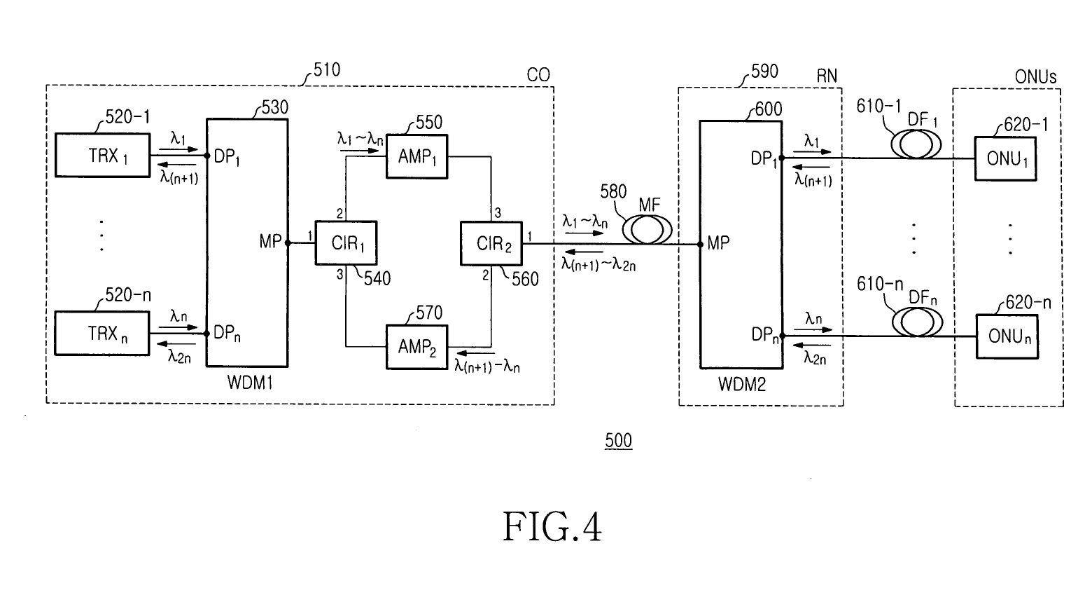

FIG. 4 illustrates a configuration of a WDM PON 500 according to a third embodiment of the present invention. The PON, 500 includes a central office (CO) 510, a remote node (RN) 590 connected to the central office 510 via a main optical fiber (MF) 580, and “n” optical network units (ONUs), ONU₁ to ONUₙ, 620-1 to 620-n, connected to the remote node 590 via corresponding distribution optical fibers (DFs), DF₁ to DFₙ, 610-1 to 610-n.

The central office 110 includes “n” transceivers, TRX₁ to TRXₙ, 520-1 to 520-n, a first wavelength division multiplexer, WDM1, 530, first and second circulators, CIR₁ and CIR₂, 540 and 560, and first and second optical amplifiers, AMP₁ and AMP₂, 550 and 570.

The TRX₁ 520-1 to TRXₙ 520-n transmit “n” downstream optical signals while receiving “n” upstream optical signals, respectively. For example, the TRXₙ 520-n outputs an n-th downstream optical signal, and receives an n-th upstream optical signal. In order to generate a downstream optical signal modulated by associated data inputted thereto, each of the TRX₁ 520-1 to TRXₙ 520-n may comprise a transmissive SOA requiring no wavelength selectivity and wavelength stability, a GC-SOA, or an RSOA.

The WDM1 530 has a multiplexing port MP, and “n” de-multiplexing ports DP₁ to DPₙ. The multiplexing port MP of the WDM1 530 is connected to the first circulator 540, whereas the “n” de-multiplexing ports DP₁ to DPₙ of the WDM1 530 are connected to the TRX₁ 520-1 to TRXₙ 520-n, respectively. The WDM1 530 multiplexes downstream optical signals inputted to the “n” de-multiplexing ports DP₁ to DPₙ and outputs a multiplexed downstream optical signals composed of the “n” inputted signals at the multiplexing port MP. The WDM1 530 also de-multiplexes an upstream optical signal, composed of “n” optical signal, inputted to the multiplexing port MP, and outputs de-multiplexed upstream optical signals to the corresponding de-multiplexing ports DP₁ to DPₙ, respectively. The WDM1 530 may comprise an AWG.

The first circulator 540 has three ports, wherein the first port is connected to the multiplexing port MP of the WDM1 530, the second port is connected to the first optical amplifier 550, and the third port is connected to the second optical amplifier 570. The first circulator 540 outputs, to the second port, the multiplexed downstream optical signal inputted to the first port, and outputs, to the first port, a multiplexed upstream optical signal inputted to the third port.

The second circulator 560 includes three ports, wherein the first port is connected to the main optical fiber 580, the second port is connected to the second optical amplifier 570, and the third port connected to the first optical amplifier 550. The second circulator 550 outputs, to the second port, the multiplexed upstream optical signal inputted to the first port, while outputting, to the first port, the multiplexed downstream optical signal inputted to the third port.

The first optical amplifier 550 connects the second port of the first circulator 540 to the third port of the second circulator 560. The first optical amplifier 550 amplifies the multiplexed downstream optical signal received from the first circulator 540, and outputs the amplified downstream optical signal to the second circulator 560. Each of the first and second optical amplifiers 550 and 570 may comprise a transmissive SOA, a GC-SOA, or an RSOA.

The second optical amplifier 570 connects the second port of the second circulator 560 to the third port of the first circulator 540. The second optical amplifier 570 amplifies the multiplexed upstream optical signal received from the second circulator 560, and outputs the amplified multiplexed upstream optical signal to the first circulator 540.

The remote node 590 includes a second wavelength division multiplexer, WDM2, 600. The WDM2 600 has a multiplexing port MP, and n de-multiplexing ports DP₁ to DPₙ. The multiplexing port of the WDM2 600 is connected to the main optical fiber (MF) 580, whereas the n d-multiplexing ports DP₁ to DPₙ of the WDM2 600 are connected to the n distribution optical fibers (DFs), DF₁ to DFₙ, 610-1 to 610-n. For example, the n-th de-multiplexing port DPₙ of the WDM2 600 is connected to the n-th distribution optical fiber, DFₙ, 610-n. The WDM2 600 de-multiplexes the provided multiplexed signal into “n” downstream optical signals, and outputs the de-multiplexed “n” optical signals to corresponding de-multiplexing ports DP₁ to DPₙ. The WDM2 600 also multiplexes “n” upstream optical signals inputted to the “n” de-multiplexing ports DP, to DPn, and outputs the multiplexed upstream optical signal to the multiplexing port MP thereof. The WDM2 600 may comprise an AWG.

ONUs, ONU₁ to ONUₙ, 620-1 to 620-n, are connected to the corresponding distribution optical fibers, DF₁ to DFₙ, 610-1 to 610-n, respectively. For example, the ONUₙ 620-n is connected to the n-th distribution optical fiber, DFₙ, 610-n. Each ONU detects a downstream optical signal received from the associated distribution optical fiber, in the form of an electrical signal. For example, the ONUₙ 620-n detects a downstream optical signal received from the n-th distribution optical fiber, DFₙ, 610-n, in the form of an electrical signal. Each ONU also generates an upstream optical signal, and transmits the generated upstream optical signal to the associated distribution optical fiber. For example, the ONUₙ 620-n generates an upstream optical signal, and transmits the generated upstream optical signal to the n-th distribution optical fiber, DFₙ, 610-n.

As apparent from the above description, the WDM PON of the present invention can be implemented, using only a transmissive SOA, a GC-SOA, or an RSOA, without using a broadband light source.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

1. A wavelength division multiplexed passive optical network (WDM PON) comprising:
a central office comprising:
a plurality of semiconductor optical amplifiers each adapted to output an optical signal modulated in accordance with data inputted thereto; and
a wavelength division multiplexer adapted to multiplex the optical signals outputted from the semiconductor optical amplifiers; and
a remote node connected to the central office via a main optical fiber adapted to distribute the optical signals received, to distribution optical fibers connected thereto; and
a plurality of optical network units connected to the remote node via the distribution optical fibers, the optical network units receiving, from the remote node, corresponding optical signals.

2. The WDM PON according to claim 1, wherein each of the semiconductor optical amplifiers comprises a transmissive semiconductor optical amplifier.

3. The WDM PON according to claim 1, wherein each of the semiconductor optical amplifiers comprises a gain-clamped semiconductor optical amplifier.

4. The WDM PON according to claim 1, wherein each of the semiconductor optical amplifiers comprises a reflective semiconductor optical amplifier.

5. The WDM PON according to claim 1, wherein the wavelength division multiplexer comprises an arrayed waveguide grating.

6. The WDM PON according to claim 1, wherein the central office further comprises:
an optical amplifier adapted to amplify the multiplexed optical signals outputted from the wavelength division multiplexer.

7. A wavelength division multiplexed passive optical network (WDM PON) comprising:
a central office comprising:
a plurality of transceivers each adapted to output a downstream optical signal modulated in accordance with data inputted thereto and to receive an upstream optical signal associated therewith: and
a wavelength division multiplexer adapted to multiplex the downstream optical signals outputted from the transceivers, and to de-multiplex upstream optical signals to be sent to corresponding ones of the transceivers;
a remote node connected to the central office via a main optical fiber, adapted to de-multiplex and distribute the downstream optical signals received onto corresponding distribution optical fibers connected thereto and to multiplex and transmit upstream optical signals received from the distribution optical fibers to the main optical fiber; and
a plurality of optical network units connected to the remote node via corresponding ones of the distribution optical fibers, the optical network units receiving from the remote node the downstream optical signals associated therewith and transmitting upstream optical signals associated therewith to the distribution optical fibers.

8. The WDM PON according to claim 7, wherein the central office further includes:
a first optical amplifier adapted to amplify the downstream optical signals received from the wavelength division multiplexer; and
a second optical amplifier adapted to amplify the upstream optical signals received from the main optical fiber.

9. The WDM PON according to claim 8, wherein the central office further includes:
a first circulator adapted to output the downstream optical signals received from the wavelength division multiplexer to the first optical amplifier, and to output the upstream optical signals received from the second optical amplifier to the wavelength division multiplexer; and
a second circulator adapted to transmit the downstream optical signals received from the first optical amplifier to the main optical fiber, and to output the upstream optical signals received from the main optical fiber to the second optical amplifier.

10. A central office within a WDN-PON comprising:
a plurality of semiconductor optical amplifiers, each generating a unique wavelength: and
a multiplexer receiving each of the generated wavelengths and multiplexing the received wavelengths into a multiplexed signal.

11. The central office as recited in claim 10, wherein the semiconductor optical amplifiers are selected from the group consisting of: transmissive, gain-clamped or reflective.

12. The central office as recited in claim 11, wherein the multiplexer is an arrayed waveguide grating.

13. The central office as recited in claim 10 further comprising:
an amplifier to amplify the multiplexed signal.

14. The central office as recited in claim 13, further comprising:
a first optical directional device receiving the multiplexed signal and providing the multiplexed signal to the amplifier;
a second optical directional device receiving the amplified multiplexed signal and providing the amplified multiplexed signal to an output port; and
a second amplifier amplifying a signal received from the output port and providing the amplified received signal to the first optical directional device, wherein the first optical directional device provides the amplified received signal to the multiplexer.

15. The central office as recited in claim 11, wherein said amplifier is selected from the group consisting of: transmissive SOA, GC-SOA, and RSOA.

16. The central office as recited in claim 10, wherein the multiplexer is an array waveguide grating.

17. The central office as recited in claim 12, wherein said second amplifier is selected from the group consisting of: transmissive SOA, a GC-SOA, and an RSOA.

18. The central office as recited in claim 10 wherein the first and second optical devices are selected from the group consisting of: coupler, splitter, tap, circulator.
